(19) United States
(12) Patent Application Publication
(10) Pub. No.: US 2023/0053408 A1
(43) Pub. Date: Feb. 23, 2023

(54) FACE MASK WITH PURIFIED AIR INSIDE

(71) Applicants: Alexander CHAK, Brooklyn, NY (US); Mark CHAK, Brooklyn, NY (US)

(72) Inventors: Alexander CHAK, Brooklyn, NY (US); Mark CHAK, Brooklyn, NY (US)

(21) Appl. No.: 17/300,565

(22) Filed: Aug. 20, 2021

(51) Int. Cl. A62B 18/00; A62B 7/12; A62B 23/02

(52) U.S. Cl. CPC A62B 18/003; A62B 7/12; A62B 23/02

(57) ABSTRACT

A face mask with purified air inside has a mask element formed so as to cover at least a part of a user's face including at least a user's nose and a user's mouth, and components for supplying into a space between the mask element and the user's nose and the user's mouth a purified air from a source outside the mask element.

### BACKGROUND OF THE INVENTION

The present invention relates to protective face masks for protection of individuals from acquiring diseases as well as for other protective purposes.

Protective face masks are well known. They are used for protection of an individual from inhaling outside air which carries microorganisms that can cause diseases. While they perform these functions they capture inside the space between a user's face and the mask the air which is exhaled by a user and also they do not continuously provide a supply of a completely new clean air between the mask and the user's face to be constantly inhaled by a user.

### SUMMARY OF THE INVENTION

Accordingly it is an object of the present invention to provide a protective face mask which avoids the disadvantages of the prior art.

In keeping with these objects and with others which will become apparent hereinafter, one feature of the present invention resides in a protective face mask which has a mask element formed so as to cover at least a part of a user's face including at least a user's nose and a user's mouth, and means for supplying into a space between the mask element and the user's nose and the user's mouth a purified air from a source outside the mask element.

When the protective face mask is designed according to the present invention, the user does not inhale his exhaled air and does not inhale air which can be contaminated by impurities, microorganisms, infectious diseases causing elements, etc.

According a further feature of the present invention, the means for supplying into a space between the mask element and the user's nose and the user's mouth a purified air from a source outside the mask element include a filter which purifies an outside air and an air supply component which supplies the thusly purified air into the space between the mask element and the user's nose and the user's mouth.

According to still a further feature of the present invention, the means for supplying into a space between the mask element and the user's nose and the user's mouth a purified air from a source outside the mask element include a container with a purified air and an air supply component which supplies the thusly purified air from the container with a purified air into the space between the mask element and the user's nose and the user's mouth.

The novel features of the present invention will be best understood from the following description of the preferred embodiments which is accompanied by the following drawings.

### BRIEF DESCRIPTION OF THE DRAWINGS

FIG. 1 of the drawings is a front view of a user's face with a protective mask covering the user's face;

FIG. 2 of the drawings is a side view of components of the present invention in accordance with a first embodiment of the invention;

FIG. 3 of the drawings is a side view of components of the present invention in accordance with a second embodiment of the invention.

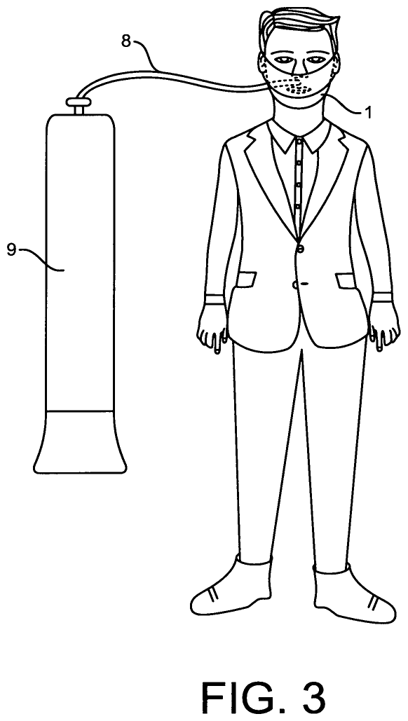

### DESCRIPTION OF THE PREFERRED EMBODIMENTS

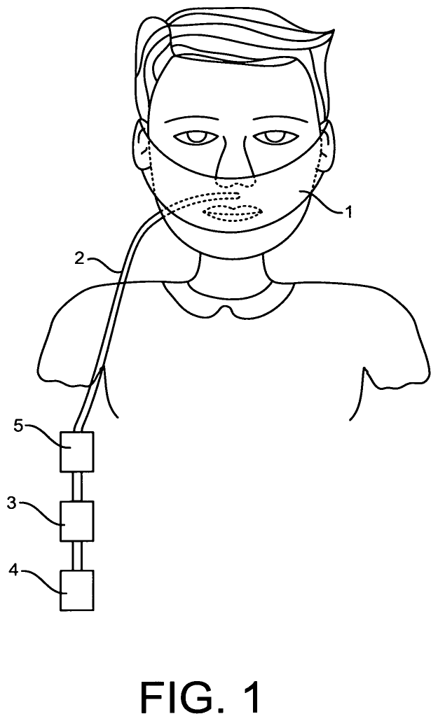

As shown in FIG. 1 a protective mask according to the present invention has a mask element 1 covering the user's face, and in particular its part containing a user's nose and a user's mouth.

In accordance with a first embodiment of the present invention shown in this FIG. 1 the protective mask further has a pipe 2 extending from a central area of the mask element 1 over a user's shoulder. The pipe 2 is connected to a ventilator or fan 3 which supplies an outside air and is operated by a motor 4 that can be battery-chargeable. It further has a filter 5 which receives the air from the ventilator 3, cleans this air and supplies the clean air into the space between the mask element 1 and the user's face, so that the user inhales the filtered clean air only.

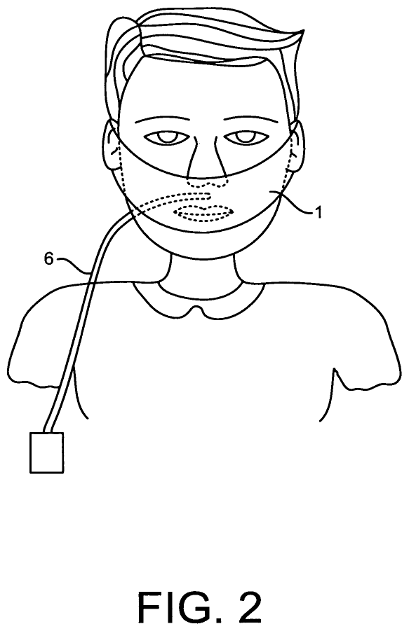

In accordance with a second embodiment of the present invention shown in FIG. 2 the protective mask further has a mask element 1 which is connected by a pipe 6 with a tank of a cylinder 7 with a clean air which is pressurized in the tank or the cylinder. When the tank or the cylinder 7 is opened by a user for example by a faucet, the clean pressurized air flows from it under pressure from it into the space between the mask element 1 and the user's face, so that the user inhales the clean air only.

It is of course possible that the clean air is not pressurized in the tank or the cylinder 7, in which case a not shown pump can be provided to pump the clean air from the tank or the cylinder 7 into the space between the mask element 1 and the user's face.

The tank or the cylinder 7 can be of a relatively small size and carried by a user. On the other hand the tank or the cylinder 7 can be of a significant size and can be stationary located in medical offices, hospitals, etc. In this case it can be used not by a single person, but by many people.

The novel features of the present invention are defined in the appended claims.

What we claim is:

1. A protective face mask, comprising
a mask element formed so as to cover at least a part of a user's face including at least a user's nose and a user's mouth; and
means for supplying into a space between the mask element and the user's nose and the user's mouth a purified air from a source outside the mask element.

2. A protective face mask as defined in claim 1, wherein the means for supplying into a space between the mask element and the user's nose and the user's mouth a purified air from a source outside the mask element include a filter which purifies an outside air and an air supply component which supplies the thusly purified air into the space between the mask element and the user's nose and the user's mouth.

3. A protective face mask as defined in claim 1, wherein the means for supplying into a space between the mask element and the user's nose and the user's mouth a purified air from a source outside the mask element include a tank with a purified air which is supplied the thusly purified air from the tank with a purified air into the space between the mask element and the user's nose and the user's mouth.

4. A protective face mask as defined in claim 3, wherein the tank with a purified air has such as size that it can be carried by a user during his/her movement.

5. A protective face mask as defined in claim 4, wherein the tank with a purified air has such as size that it is arranged stationarily
